(19) United States
(12) Patent Application Publication
(10) Pub. No.: US 2016/0247214 A1
(43) Pub. Date: Aug. 25, 2016

(54) SYSTEM AND METHOD FOR PROVIDING RESPONSE INFORMATION ON PRODUCT BY EXISTING USERS THROUGH NETWORK

(71) Applicant: NAVER CORPORATION, Seongnam-si (KR)

(72) Inventors: Tae Il Kim, Seongnam-si (KR); Hyun Jung Lee, Seongnam-si (KR); Chiaki Kodama, Seongnam-si (KR); Dong Hyun Kim, Seongnam-si (KR); Jun Hyuk Shim, Seongnam-si (KR); Jin Woo Lee, Seongnam-si (KR); Cheol Gyun Lee, Seongnam-si (KR); Jae Kyun Yoo, Seongnam-si (KR); Jae Bok Yi, Seongnam-si (KR); Seong Jin Choi, Seongnam-si (KR)

(21) Appl. No.: 14/864,073

(22) Filed: Sep. 24, 2015

(30) Foreign Application Priority Data
Feb. 24, 2015 (KR) 10-2015-0026088

(51) Int. Cl. G06Q 30/06; H04L 29/08

(52) U.S. Cl. CPC G06Q 30/0623; H04L 67/32

(57) ABSTRACT

Disclosed herein is a system and method for providing ‘response information’, which is information on usage comments, reviews, or evaluations written by existing users, so that a specific user who requests product information may easily and accurately know it in a shorter time, when the product information is provided through a network according to the request or search by the specific user, where the system includes a pattern extraction unit that extracts a reputation pattern including an attribute word corresponding to a specific product by analyzing one or more pieces of existing user's response information for the product for which product information is provided through a network, a summary information extracting unit that extracts summary information on the response information based on the reputation pattern, and a summary information providing unit providing the extracted summary information to be displayed for the user to read to a client.

### BACKGROUND OF THE INVENTION

1. Field of the Invention

The present invention relates, in general, to a service for providing product information through a network and more particularly, to a service system and method for providing ‘response information’, which is information on usage comments, reviews, or evaluations written by existing users for a corresponding product, when information on the product is provided through a network according to a specific user's request or search.

2. Description of the Related Art

Recently, there has appeared the case where an online commercial trade system is combined with a search engine or portal site. Since there are more cases where a user wants to receive additional information on products to purchase than cases where the user simply wants to receive academic or suggestive information through a search request, a user's search request from a portal site or search engine may be understood as targeting an integrated or complex search.

Generally, since many products are traded on an online commercial trade network and frequently emerge in and disappear from the market, there have been many technical attempts to more efficiently provide product information required by a specific user. In particular, since it is difficult to directly see or taste a selected genuine product in an online trade, a user's determination on whether to purchase may be greatly influenced by referring to ‘response information’, which is information on usage comments, reviews, or evaluations written by existing users.

In addition, from the point of view of an entity who manufactures a product in order to sell or otherwise provide it, since the customer's response to a corresponding product may be understood through the foregoing response information, future development and sales planning may be affected thereby.

Accordingly, in many online commercial trade-related services, the foregoing response information from existing users may be provided in various types. FIG. 1 illustrates an example of providing the existing users' response information on a specific product according to a related art. As illustrated in FIG. 1, method 1a is frequently used in which responses or evaluations for a corresponding product are divided in certain score category (e.g. categories of five stars, four stars, three stars, two stars, one star, or the like), the existing users are led to click the score categories, and the click ratios of existing users on the score categories are displayed on a screen. In addition, as illustrated in the bottom portion of FIG. 1, even in the case of presenting usage comments, which are one type of the response information, methods 1b to 1d are generally used, in which the existing users' usage comments are simply listed.

However, in the related art methods, there is a limitation in the ability to accurately deliver the existing users' response information on the features or performance of a corresponding product. In addition, there is also limited time for a user to attentively read a large number of usage comments in order to obtain the existing users' response information. In addition, since most usage comments include peripheral or unnecessary content, rather than accurate and meaningful information required for purchasing the product, they are usually not suitable for rapidly obtaining essential content pertaining to the features of the corresponding product. Therefore, these typical methods are not greatly helpful to a user who tries to rapidly and accurately obtain the existing users' response information and determine whether to purchase the specific product, or to the providers of the product who try to rapidly and accurately grasp users' responses to the corresponding product.

### CITATIONS OF PRIOR ART

### Patent Literatures

Patent literature 1: Korean Patent No. 10-0890422

Patent literature 2: Korean Patent Application Laid-open Publication No. 10-2008-0015233

Patent literature 3: Korean Patent Application Laid-open Publication No. 10-2013-0028216

### SUMMARY OF THE INVENTION

Accordingly, the present invention has been made keeping in mind the above problems occurring in the prior art, and an object of the present invention is to provide a system and method for providing ‘response information’, which is information on usage comments, reviews, or evaluations written by existing users for a corresponding product, so that a specific user who requests product information may easily and accurately obtain it in a shorter time, when the product information is provided through a network according to the request or search of the specific user.

Another object of the present invention is to provide a system and method for enabling a user to rapidly and accurately obtain and refer to existing users' response information in order to determine whether to purchase a specific product by providing essential content of the existing users' response information on the specific product in a type of summary information, such as an excerpt.

A further object of the present invention is to provide a system and method for providing essential content of the existing users' response information on a specific product in a type of summary information such as an excerpt in order to enable a product provider or the like, who tries to obtain consumers' responses for the specific product, to refer to the essential content.

Yet another object of the present invention is to provide a system and method for providing the existing users' response information for a specific product so that a user or product provider may rapidly refer to clearly organized excerpts in a single view, even when not reading the user comments one by one in a window.

Still another object of the present invention is to provide a system and method for providing summary information in a highlighted manner together with the existing users' comments in order to enable a user to rapidly and accurately obtain the existing users' response information on a specific product.

Still another object of the present invention is to provide a system and method for providing the existing users' response information on a specific product by classifying, by each topic, response information matched with attributes of the specific product and allowing the classified response information to be rapidly read by a user or product provider and accordingly to be useful for the user when purchasing or for the product provider when selling.

In order to accomplish the above objects, the present invention provides a system for providing users' response information, including: a pattern extraction unit, which extracts a reputation pattern including an attribute word corresponding to a specific product by analyzing one or more pieces of existing users' response information for the product for which product information is provided through a network; a summary information extracting unit, which extracts summary information on the response information on the basis of the reputation pattern; and a summary information providing unit, which provides the extracted one or more pieces of summary information to be displayed for user's reading to a client connected through the network.

In order to accomplish the above object, the present invention provides a system for providing users' response information, including: a pattern extraction unit, which extracts a reputation pattern including an attribute word corresponding to a specific product by analyzing one or more pieces of existing users' response information for the specific product for which product information is provided through a network; a topic determining unit, which determines a topic related to the attribute word; and a topic menu providing unit, which classifies the response information or summary information according to the topic and provides a topic selection menu to a client connected through the network in order to display the topic selection menu.

In order to accomplish the above object, the present invention provides a method of providing user response information, which is executed in a server system that provides product information for a specific product over a network. The method includes: a pattern extracting operation for extracting a reputation pattern including an attribute word corresponding to a specific product by analyzing one or more pieces of existing users' response information for the product, a summary information extracting operation for extracting summary information from the response information based on the reputation pattern, and a summary information providing operation for providing the extracted one or more pieces of summary information, to be displayed in order to be read by a user, to a client connected through the network. In order to accomplish the above object, the present invention provides a method of providing user response information, which is executed in a server system that provides product information for a specific product through the network. The method includes: a pattern extracting operation for extracting an attribute word corresponding to a specific product by analyzing one or more pieces of existing users' response information for the product, a topic determining operation for determining a topic related to the attribute word, and a topic menu providing operation for classifying the response information or summary information according to the topic and providing a topic selection menu to a client connected through a network to display the topic selection menu.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates examples of providing existing users' response information on a specific product according to related art;

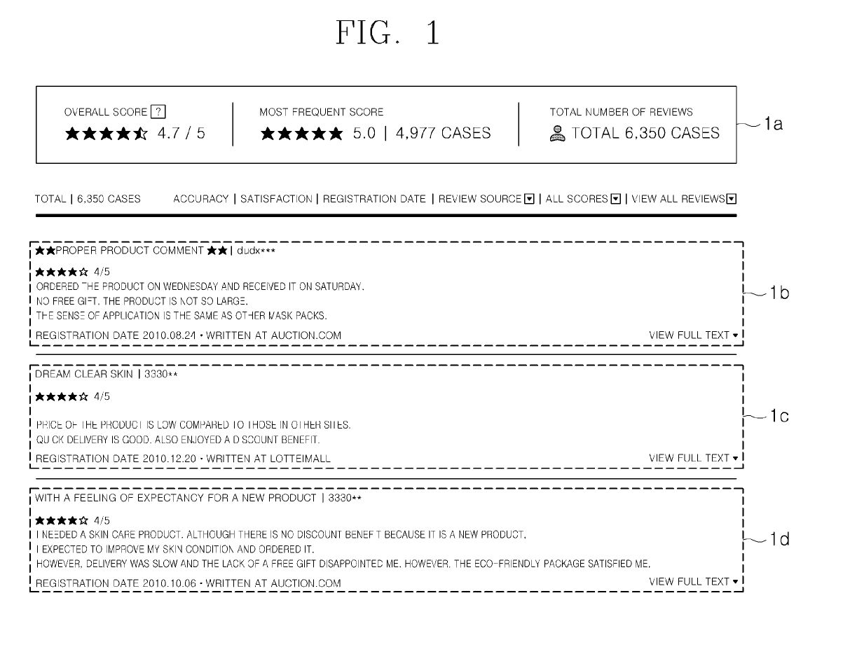

FIG. 2 is an exemplary illustration of a result of providing users' response information according to an embodiment of present invention;

FIG. 3 is another exemplary illustration of a result of providing users' response information according to another embodiment the present invention;

FIG. 4 is another exemplary illustration of a result of providing users' response information according to further embodiment of the present invention;

FIG. 5 is a block diagram of an embodiment of a system for providing users' response information according to the present invention;

FIG. 6 is an exemplary diagram for explaining a process for constructing a dictionary database in the system exemplified in FIG. 5; and

FIG. 7 is a flowchart for explaining a method for providing users' response information according to the present invention.

### DESCRIPTION OF THE PREFERRED EMBODIMENTS

Hereinafter, embodiments of the present invention will be described in detail with reference to the attached drawings.

Reference now should be made to the drawings, in which the same reference numerals are used throughout the different drawings to designate the same or similar components.

The terminology used herein is for the purpose of describing particular embodiments only and is not intended to limit the right scope of the invention. Unless otherwise defined, all terms used herein have the same meaning as commonly understood by one of ordinary skill in the art to which this invention pertains, and should not be interpreted as having an excessively comprehensive meaning nor as having an excessively contracted meaning. If technical terms used herein fail to accurately express the technical idea of the present invention, they should be replaced with technical terms that allow the person in the art to properly understand. In addition, general terms used herein should be interpreted according to the definitions in the dictionary or in context, and should not be interpreted as having excessively contracted meanings.

As used herein, the singular forms “a,” “an” and “the” are intended to include the plural forms as well, unless the context clearly indicates otherwise. In the present application, such terminology as ‘configured’, ‘include’ and the like should be construed not as necessarily including various components or steps written in the present specification but as including the components or steps in part or further including additional components or steps.

It will be understood that, although the terms “first”, “second”, etc., may be used herein to distinguish one element from another element, the terms are not meant to be limiting. These terms are only used to distinguish one element from another. For example, a first element could be termed a second element, and, similarly, a second element could be termed a first element, without departing from the scope of example embodiments.

Reference will now be made in detail to the embodiments of the present disclosure, examples of which are illustrated in the accompanying drawings, in which like numbers refer to like elements throughout, and repetitive explanations will be omitted.

In the following description, detailed descriptions of well-known functions or constructions will be omitted since they would obscure the invention in unnecessary detail. The accompanying drawings are used to help easily understand the technical idea of the present invention, and it should be understood that the idea of the present invention is not limited by the accompanying drawings.

‘Response information’ described herein refers to information on usage comments, reviews, or evaluations written by the existing users of a specific product.

In addition, ‘reputation pattern’ described herein refers to representation from which a user's evaluation pertaining to performance, effect, quality, or the like of a specific product may be connotatively obtained, and may be a representation including attribute words pertaining to the corresponding product, such as “price”, “design”, and “flexibility”. As another example, the expression may include a combination such as “price is low”, “design is good”, “flexibility is high”, or the like of the attribute word (e.g. “price”, “design”, “flexibility”, or the like in the foregoing example) and a predicative word (e.g. “low”, “good”, “high”, or the like in the foregoing example). Here, the predicative word may include content classified as having the meaning of either affirmation or negation.

In addition, ‘summary information’ described herein refers to an ‘excerpt’ extracted based on the reputation pattern from the ‘response information’, and refers to content summarized so as to be shorter in length or quantity thereof in comparison to the response information.

In addition, ‘topic’ described herein refers to a classification theme word that is identical or related to the specific product.

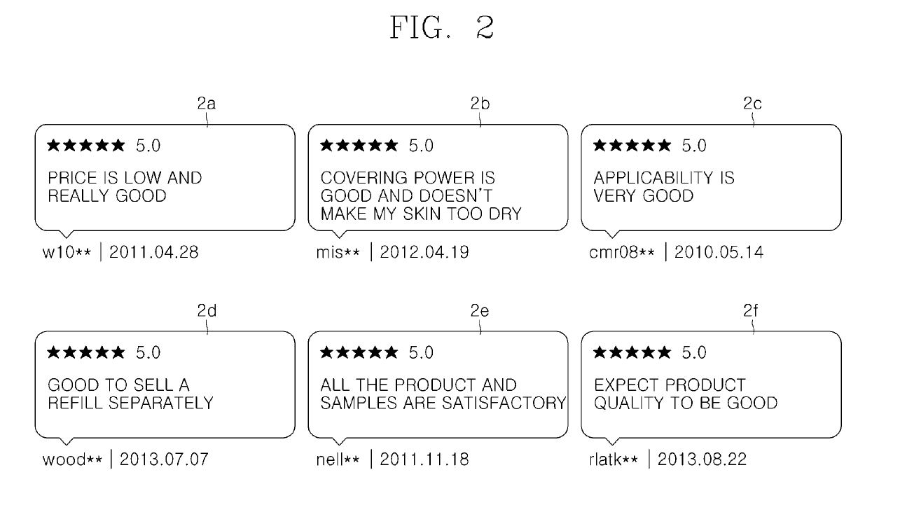

FIG. 2 is an exemplary illustration of a result of providing users' response information (e.g. for specific cosmetics) according to the present invention. As illustrated, a user may rapidly and accurately obtain content of the existing users' response information on the corresponding product by listing only the summarized information (i.e. excerpts) extracted based on the reputation pattern extracted from the response information, such as the existing users' longer or detailed usage comments. In the illustrated summary information screens 2a to 2f, the reputation pattern includes a combination of an attribute word (e.g. “price”, “covering power”, “dryness”, “sense of application”, “refill”, “product”, “sample”, “quality”, or the like) and a predicative word (e.g. “economic”, “exist”, “good”, “good”, “satisfied”, “good”, or the like). In other words, the user may obtain the essentials in a single view through a summary information screen, in which essential content is summarized in this way, without needing to bring the many longer usage comments up on the screen and read the long usage comments one by one.

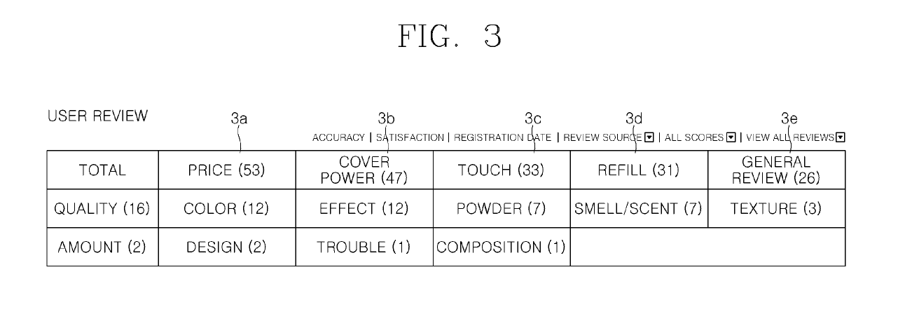

FIG. 3 is another exemplary illustration of the result of providing users' response information (e.g. for specific cosmetics) according to the present invention. As illustrated, the existing users' response information, such as usage comments, is divided by each topic to be reviewed.

For example, in examples 3a to 3e, the case 3a relating to ‘price’ has the largest number of cases, namely 53, among the large number of usage comments, and the case 3b relating to ‘cover power’ has the second largest number of cases, namely 47. Here, the user may read corresponding usage comments in detail by clicking each topic item shown on a user's display, as illustrated in FIG. 3, or may see excerpts shown on the summary information screens 2a to 2f, as illustrated in FIG. 2.

Here, the topic may be identical to an attribute word of the foregoing specific product or a related classification theme word. For example, ‘dryness’ and ‘allergy’, which may be attribute words for specific cosmetics, may be classified together as a topic related to a generic concept called ‘trouble,’ according to their frequency of appearance among the usage comments, or for the convenience of database management.

In addition, the screen of FIG. 3 may be modified and practiced in various types, and may be implemented to have a tree structure by dividing each topic into sub-categories and again dividing the sub-categories into further categories. The graphic displayed on the screen in FIG. 3 may also be modified in various UI types, including text or an icon.

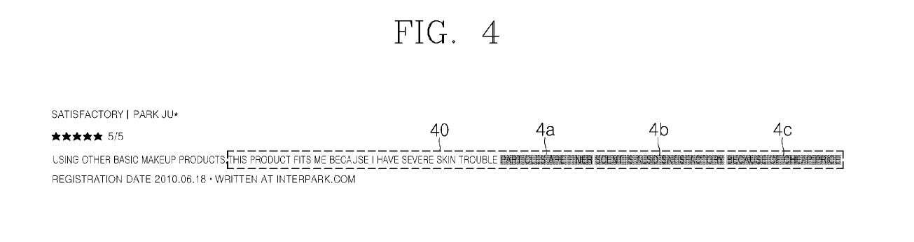

FIG. 4 is another exemplary illustration of the result of providing users' response information (e.g. for specific cosmetics) according to the present invention. As illustrated, the user may rapidly and accurately obtain content of the existing users' response information for the corresponding product by listing the summary information (i.e. excerpts) 4a, 4b and 4c in a highlighted manner in the user comments themselves 40, which include words corresponding to the summary information extracted based on the reputation pattern extracted from the response information, such as the longer usage comments or the like.

In other words, the user may obtain the essentials in a shorter time through this highlighting (“particles are finer”, “scent is also satisfactory”, “because of cheap price”, or the like) without reading many long usage comments one by one. As illustrated in FIG. 4, according to the highlight type, all corresponding expressions may be highlighted, each of the attribute words or predicative words may be highlighted, or only the attribute words or only predictive words may be highlighted. As for the shape of the highlight, various types may be employed for distinguishing the corresponding expression from other parts of the text, which include highlights as with highlight pens or a change in the character color or font.

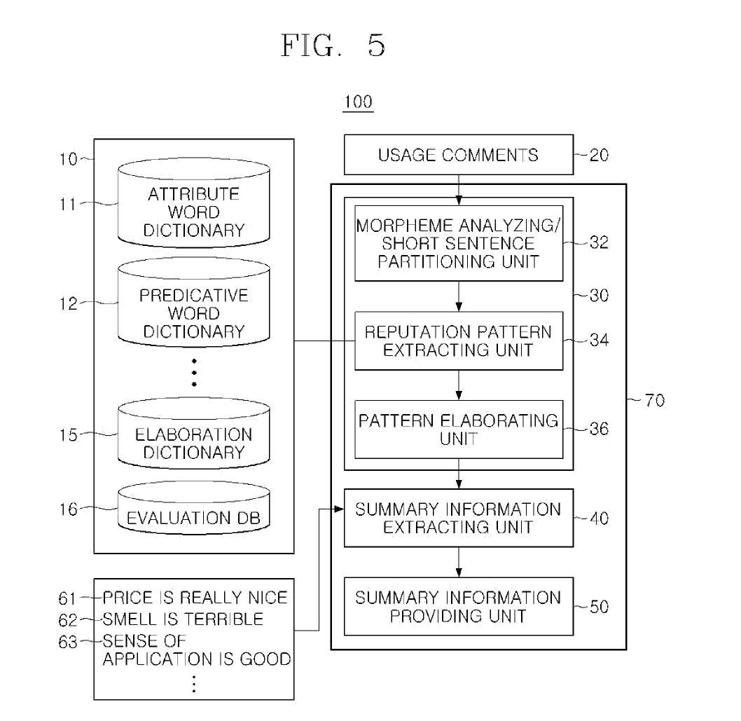

FIG. 5 is a block diagram illustrating an exemplary embodiment of a system 100 for providing users' response information according to the present invention. The system 100 includes a usage comment database 20 storing a plurality of existing users' usage comments for each product for which product information is provided to the users through a network.

In addition, the system 100 includes a dictionary database 10, which includes a product attribute word dictionary database 11 and a predicative word dictionary database 12. Additionally, the dictionary database 10 further includes an elaboration dictionary database 15 used for distinguishing colloquialisms, slang, useless words, spelling mistakes, or the like, if necessary. In addition, the dictionary database 10 further includes an evaluation database 16, in which an affirmative or negative field item is given to each pair of an attribute word and a predicative word.

The system 100 includes a pattern extraction unit 30, which includes a morpheme analyzing/short sentence partitioning unit 32 for analyzing usage comments stored in the usage comment database 20 to perform morpheme analysis and short sentence partitioning. The specified process may be performed using a method known to those skilled in the art, and accordingly a description thereof is omitted. The pattern extraction unit 30 includes a reputation pattern extraction unit 34 for querying the dictionary database 10 about the result and extracting a reputation pattern (e.g. “price is low”, “design is good”, “flexibility is high”, or the like) including a combination of the attribute word and predicative word.

At this point, the pattern extraction unit 30 may classify the usage comments (or excerpts thereof) as affirmative or negative by using the evaluation database 16, in which an affirmative or negative field item is given to each pair of attribute word and predicative word.

In addition, the pattern extraction unit 30 may perform a quantitative evaluation for the usage comments (or excerpts thereof), and as an example, an intensifying adverb may be additionally considered together with an attribute word or predicative word extracted from the usage comments in this process. For example, when an intensifying word such as “very”, “greatly”, “extremely”, or “quite” appears in sequence with the attribute word or predicative word, a corresponding usage comment (or excerpt thereof) may be quantitatively evaluated to have a high degree of affirmation or negation compared to the case where there is no intensifying word.

In addition, the pattern extraction unit 30 of the system 100 further includes a pattern elaborating unit 36 for elaborating the extracted reputation pattern, which is for faithfully reflecting expression written by a user in an excerpt, since the usage comment, which is a general user's article, may include colloquialism, a slang, a useless word, a spelling mistake, or the like. To this end, the elaboration dictionary database 15 is used.

In addition, the system 100 includes a summary information extracting unit 40, which is for writing an excerpt from a long usage comment by comparing the extracted reputation pattern (or elaborated reputation pattern) with a target usage comment.

Summary information obtained in this way includes only the reputation pattern to be provided in a pithy manner (e.g. “price is low”, “design is good”, “flexibility is high”, or the like), or to be provided together with a faithful expression of the original text in relation to the corresponding part. For example, the corresponding part of the original text expression, such as “price is really nice” 61, “smell is terrible” 62, or “sense of application is good” 63 (shown in FIG. 5) may be provided without change.

In addition, the system 100 includes a summary information providing unit 50, which is for displaying the excerpt in a highlighted type (e.g. as illustrated in FIG. 4) or in a separated type (e.g. as illustrated in FIG. 2), or providing classification by topic (e.g. as illustrated in FIG. 3) according to a user's selection, together with the usage comments for the product when a specific user requests information on a corresponding product through a network.

The pattern extraction unit 30, the summary information extracting unit 40 and/or the summary information providing unit 50 may be implemented as software executable on a computer. A computer can execute the software to process the usage comment from the usage comment database 20 to provide a response information with assistance of the dictionary database 10.

Furthermore, the pattern extraction unit 30, the summary information extracting unit 40 and/or the summary information providing unit 50 may also be implemented as hardware (e.g. server, electronic equipment, etc.). The pattern extraction unit 30, the summary information extracting unit 40 and/or the summary information providing unit 50 may be configured as at least one microprocessor which may be controlled by at least one program stored in memory (not shown).

A server 70, including the pattern extraction unit 30, the summary information extracting unit 40 the summary information providing unit 50, process the usage comment from the usage comment database 20 to provide a response information with assistance of the dictionary database 10.

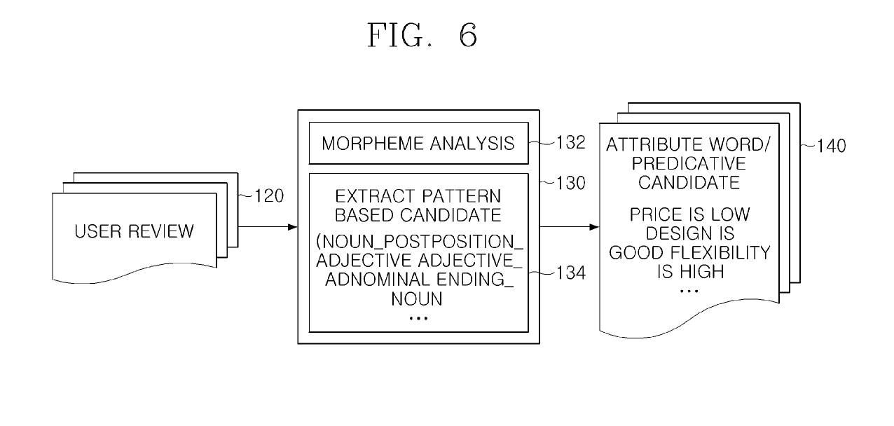

FIG. 6 is an illustration for explaining a process for constructing a database in advance in the exemplified system in FIG. 5. As an example, when the existing users' usage comments are accumulated, the dictionary database 10 may be constructed using this process. For example, as illustrated, the pattern-based attribute word and predicative word candidates are extracted 134 using nouns and adjectives obtained by performing morpheme analysis 132 for many usage comments (or user reviews) for a corresponding product, which are accumulated in a user comment database 120, and the attribute word dictionary database (11 of FIG. 5) and the predicative word dictionary database (12 of FIG. 5) are constructed 140 by using these (this dictionary construction process may employ technology known to those skilled in the art).

In addition, the elaboration dictionary database (15 in FIG. 5) can be used for distinguishing colloquialisms, slangs, useless words, and spelling mistakes, and the evaluation database (16 of FIG. 5), in which an affirmative or negative field item is given to each pair of an attribute word and a predicative word.

If necessary, the various dictionary databases, such as the attribute word dictionary database (11 of FIG. 5) may be included by manual work or by referring to a pre-constructed thesaurus dictionary or various glossaries according to the type and feature of the corresponding product.

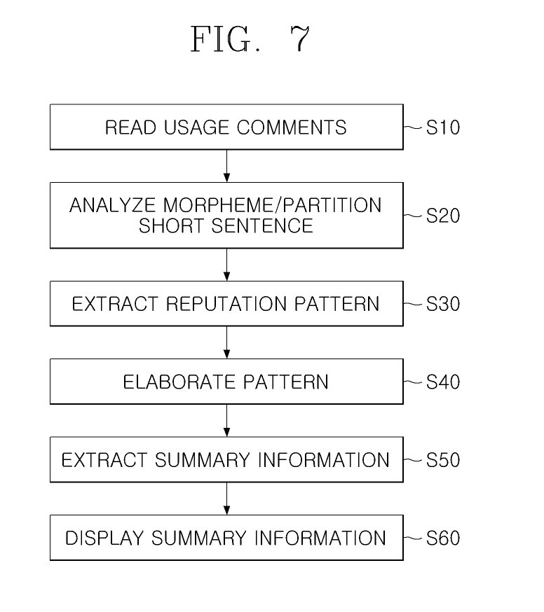

FIG. 7 is a flowchart for explaining the flow of an embodiment of a method for providing users' response information according to the present invention.

In this embodiment, the server 70 reads (operation S10) one or more pieces of existing users' response information (usage comments or the like) from the user comment database 120 for a corresponding product for which product information is provided and performs morpheme analysis or short sentence division to extract (operation S30) a reputation pattern including a combination of an attribute word and a predicative word corresponding to the corresponding product.

In addition, the server 70 performs a summary information extracting operation S50 for extracting summary information about the response information based on the reputation pattern. This is for writing an excerpt from a long usage comment by comparing the extracted reputation pattern (or elaborated reputation pattern) with the target user comment.

Furthermore, the server 70 performs the summary information providing operation S60 for providing or displaying the extracted one or more pieces of summary information together with the one or more pieces of response information on a user's display for the user to read.

In addition, at the time of extracting the reputation pattern (operation S30), a quantitative evaluation of the usage comments (or excerpts thereof) may be performed. For example, an intensifying adverb may be additionally considered together with an attribute word or predicative word extracted from the usage comments. For example, when an intensifying word such as “very”, “greatly”, “extremely”, or “quite” appears in sequence with the attribute word or predicative word, a corresponding usage comment (or excerpt thereof) may be quantitatively evaluated to have a high degree of affirmation or negation compared to the case where such a word is absent.

In addition, in the foregoing embodiment, a pattern elaboration operation S40 may be further included for elaborating the extracted reputation pattern, which serves to faithfully reflect an expression written by a user in an excerpt without changing it, since the usage comment, which is a general user's article, may include a colloquialism, slang, a useless word, a spelling mistake, or the like. To this end, the elaboration dictionary database 15 is used.

In addition, as another embodiment of a method for providing users' response information in the present invention, another type is also possible which includes a pattern extracting operation for analyzing one or more pieces of the existing users' response information (usage comments or the like) for a specific product in order to extract an attribute word corresponding to the corresponding product, a topic determining operation for determining an attribute-related topic, and a topic menu providing operation for classifying response information or summary information according to topic and providing a topic selection menu to a connected client through a network in order to display the topic selection menu.

As a result, a topic determining unit can determine the menu for each topic, and the menu may be provided to a user by a topic menu providing unit as illustrated in FIG. 3, and when the user selects any one of them, usage comments or summary information thereon, which includes content that matches a corresponding topic, may be provided.

The above-described various embodiments of the present invention may also be implemented as a system for providing users' response information according to the present invention. The system may include a pattern extraction unit extracting a reputation pattern including an attribute word corresponding to a specific product by analyzing one or more pieces of existing users' response information for the product of which product information is provided through a network, a topic determining unit determining a topic related to the attribute word, and a topic menu providing unit classifying the response information or summary information according to the topic and providing a topic selection menu to a client connected through the network to display the topic selection menu.

The pattern extraction unit, topic determining unit and/or topic menu providing unit can be implemented as software executable on a computer.

Furthermore, the pattern extraction unit, the topic determining unit and/or the topic menu providing unit can be also implemented as hardware (e.g. server, electronic equipment, etc.) The pattern extraction unit, the topic determining unit and/or the topic menu providing unit may be configured as at least one microprocessor which may be controlled by at least one program stored in memory (not shown).

The above-described various embodiments of the present invention may be implemented as program instructions to be stored in a computer-readable storage medium. The computer-readable recording medium may include program instructions, data files, and data structures, either independently or in a combined manner. The program instructions recorded on the computer-readable recording medium are specifically designed and configured for the present invention, but may be known to those skilled in the art of computer software field to be useable. Examples of the computer-readable recording medium include a magnetic medium including a hard disk, floppy disk, and magnetic tape, an optical recording medium such as a CD-ROM or DVD, a magneto-optical media such as a floptical disk, and a hardware device particularly configured to store and execute the program instructions, such as ROM, RAM, and flash memory. Program instructions may include high-level language code executable by a computer using an interpreter in addition to machine code created by a complier. The hardware device may be configured to operate as at least one software module to perform an operation of various embodiments and vice versa.

The particular implementations shown and described herein are illustrative examples of the presently disclosed embodiment, and are not intended to otherwise limit the scope of the invention in any way. For the sake of brevity, conventional electronics, control systems, software development and other functional aspects of the systems may not be described in detail. Furthermore, the connecting lines or connecting members shown in the various figures presented are intended to represent exemplary functional relationships and/or physical or logical couplings between the various elements, and many alternative or additional functional relationships, physical connections or logical connections may be present in a practical device. Moreover, no item or component may be essential to the practice of the invention unless the element is specifically described as “essential” or “critical”.

The use of the term “the” and similar referents in the context of describing the presently disclosed embodiment (especially in the context of the following claims) is to be construed to cover both the singular and the plural. Furthermore, the recitation of ranges of values herein is merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The present invention is not limited to the described order of the steps. The use of any and all examples, or exemplary language (e.g., “such as”) provided herein, is intended merely to better illuminate the invention and does not pose a limitation on the scope of the presently disclosed embodiment unless otherwise claimed. Additionally, it will be understood by those of ordinary skill in the art that various modifications, combinations, and changes can be formed according to the design conditions and factors within the scope of the attached claims or the equivalents.

According to the present invention, when the product information is provided through a network according to a request or search of a specific user, the specific user who requests product information may easily and accurately obtain ‘response information,’ which is information on usage comments, reviews, or evaluations written by the existing users for a corresponding product, in a shorter time.

In addition, according to the present invention, since essential content of existing users' response information on a specific product is provided as a type of summary information such as an excerpt, a user may rapidly and accurately obtain and refer to the existing users' response information in order to determine whether to purchase the specific product.

In addition, according to the present invention, since essential content of the existing users' response information on the specific product is provided in the form of summary information such as an excerpt, a product provider or the like, who tries to obtain customers' responses for the specific product, may usefully refer to the essential content.

In addition, according to the present invention, since the existing users' response information for the specific product is provided so that a user or product provider may rapidly refer to clearly organized excerpts in a single view, even when not reading the user comments one by one on a window screen, rapid reference by a user or product provider is possible.

In addition, according to the present invention, since summary information is provided in a highlighted manner together with the existing users' comments, rapid and accurate understanding is possible.

In addition, according to the present invention, since the existing users' response information for the specific product is provided by classifying, by each topic, response information matched with attributes of the specific product and allowing the classified response information to be rapidly read by a user or product provider, the response information may be useful for the user when purchasing and for the product provider when selling.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for providing user response information comprising:
a pattern extraction unit extracting a reputation pattern including an attribute word corresponding to a specific product by analyzing one or more pieces of existing users' response information for the specific product, of which product information is provided through a network;
a summary information extracting unit extracting summary information on the response information on a basis of the reputation pattern; and
a summary information providing unit providing the extracted one or more pieces of summary information to be displayed for a user's reading, to a client connected through the network.

2. The system of claim 1, wherein the summary information providing unit classifies the summary information by each topic related to the attribute word on a basis of the extracted reputation pattern and provides the classified summary information.

3. The system of claim 2, wherein the summary information providing unit provides the classified one or more pieces of summary information when the user selects one or more topics displayed on a screen.

4. The system of claim 1, wherein the summary information providing unit provides the one of more pieces of summary information in a type of one or more grouped excerpts separately from the one or more pieces of response information.

5. The system of claim 1, wherein the summary information providing unit provides the one or more pieces of summary information in a type such that the one or more pieces of response information is highlighted, together with provision of the one or more pieces of the response information.

6. The system of claim 1, wherein the response information is information on the existing users' usage comment, review, or evaluation for the specific product.

7. The system of claim 1, wherein the reputation pattern extracted by the pattern extraction unit includes a combination of an attribute word, corresponding to the corresponding product, and a predicative word.

8. The system of claim 1, wherein the pattern extraction unit further includes a dictionary database constructing unit performing a morpheme analysis for the one or more pieces of response information to construct a database of a candidate of the attribute word corresponding to the specific product or the predicative word.

9. The system of claim 1, wherein the pattern extraction unit classifies the one or more pieces of response information into an affirmation or negation on a basis of the reputation pattern.

10. The system of claim 1, wherein the pattern extraction unit performs a quantitative evaluation for the one or more pieces of response information, and an intensifying adverb extracted from the response information is considered for the quantitative evaluation.

11. The system of claim 1, further including a pattern elaborating unit performing pattern elaboration such that one or more items of a colloquialism, slang, and a spelling mistake are considered together with a combination of the attribute word and predictive word extracted from the response information.

12. A system for providing user response information comprising:
a pattern extraction unit extracting a reputation pattern including an attribute word corresponding to a specific product by analyzing one or more pieces of existing users' response information for the product of which product information is provided through a network;
a topic determining unit determining a topic related to the attribute word; and
a topic menu providing unit classifying the response information or summary information according to the topic and providing a topic selection menu to a client connected through the network to display the topic selection menu.

13. A method of providing user response information, which is executed in a server system providing product information for a specific product through the network, the method comprising:
a pattern extracting operation for extracting a reputation pattern including an attribute word corresponding to a specific product by analyzing one or more pieces of existing users' response information for the product;
a summary information extracting operation for extracting summary information on the response information on a basis of the reputation pattern; and
a summary information providing operation for providing the extracted one or more pieces of summary information to be displayed for user's reading to a client connected through the network.

14. A method of providing user response information, which is executed in a server system providing product information for a specific product through the network, the method comprising:
a pattern extracting operation for extracting an attribute word corresponding to a specific product by analyzing one or more pieces of existing user's response information for the product;
a topic determining operation for determining a topic related to the attribute word; and
a topic menu providing operation for classifying the response information or summary information according to the topic and providing a topic selection menu to a client connected through the network to display the topic selection menu.
